(19) United States
(12) Patent Application Publication
(10) Pub. No.: US 2025/0338277 A1
(43) Pub. Date: Oct. 30, 2025

(54) UPLINK TRANSMIT SWITCHING FOR SIDELINK AND UPLINK BANDS

(71) Applicant: QUALCOMM INCORPORATED, San Diego, CA (US)

(72) Inventors: Yiqing Cao, Beijing (CN); Peter Gaal, San Diego, CA (US); Juan Montojo, San Diego, CA (US); Bin Han, Beijing (CN)

(21) Appl. No.: 18/866,038

(22) PCT Filed: Aug. 4, 2022
(86) PCT No.: PCT/CN2022/110162

§ 371 Date: Nov. 14, 2024

(51) Int. Cl. H04W 72/21; H04W 8/24; H04W 72/1268

(52) U.S. Cl. CPC H04W 72/21; H04W 8/24; H04W 72/1268

(57) ABSTRACT

Methods, systems, and devices for wireless communication are described. In a wireless communication system, a user equipment (UE) may be capable of performing uplink transmit switching from an uplink band to a sidelink band. Additionally, the UE may support performing uplink transmissions on the uplink band, the sidelink band, or both simultaneously. The UE may receive a grant scheduling an uplink message for transmission over a set of one or more transmit ports. If the UE is unable to transmit the uplink message on the scheduled band (e.g., the uplink band) using the set of transmit ports indicated in the grant, the UE may switch a transmitter from the uplink band to the sidelink band, and the UE may transmit the uplink message using the sidelink band according to the grant.

### CROSS REFERENCE

The present Application is a 371 national stage filing of International PCT Application No. PCT/CN2022/110162 by Cao et al. entitled “UPLINK TRANSMIT SWITCHING FOR SIDELINK AND UPLINK BANDS,” filed Aug. 4, 2022, which is assigned to the assignee hereof, and which is expressly incorporated by reference in its entirety herein.

### FIELD OF TECHNOLOGY

The following relates to wireless communication, including uplink transmit switching for sidelink and uplink bands.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support uplink transmit switching for sidelink and uplink bands. For example, the described techniques provide for uplink switching between an uplink band and a sidelink band, which may increase signaling throughput, spectral efficiency, and resource utilization. In some examples, a user equipment (UE) may transmit a capability message indicating a capability of the UE to perform uplink switching between an uplink band and a sidelink band. In some examples, the UE may be capable of communicating via the uplink band independently, the sidelink band independently, or the uplink band and the sidelink band simultaneously. The UE may receive a grant scheduling an uplink message transmission via a set of one or more transmit ports. If the UE is unable to transmit the uplink message using the transmit ports and the scheduled band, the UE may switch from transmitting using the uplink band to the sidelink band, and the UE may accordingly transmit the uplink message using the sidelink band.

A method for wireless communication is described. The method may include transmitting a capability message indicating a capability of a UE to perform uplink switching between an uplink band and a sidelink band, receiving a grant scheduling an uplink message for transmission over a set of one or more transmit ports, switching a transmitter of the UE from the uplink band to the sidelink band based on the set of one or more transmit ports and the capability message, and transmitting the uplink message using the sidelink band according to the grant and based on the switching.

An apparatus for wireless communication is described. The apparatus may include a processor, memory in electronic communication with the processor, and instructions stored in the memory. The instructions may be executable by the processor to transmit a capability message indicating a capability of a UE to perform uplink switching between an uplink band and a sidelink band, receive a grant scheduling an uplink message for transmission over a set of one or more transmit ports, switch a transmitter of the UE from the uplink band to the sidelink band based on the set of one or more transmit ports and the capability message, and transmit the uplink message using the sidelink band according to the grant and based on the switching.

Another apparatus for wireless communication is described. The apparatus may include means for transmitting a capability message indicating a capability of a UE to perform uplink switching between an uplink band and a sidelink band, means for receiving a grant scheduling an uplink message for transmission over a set of one or more transmit ports, means for switching a transmitter of the UE from the uplink band to the sidelink band based on the set of one or more transmit ports and the capability message, and means for transmitting the uplink message using the sidelink band according to the grant and based on the switching.

A non-transitory computer-readable medium storing code for wireless communication at a UE is described. The code may include instructions executable to transmit a capability message indicating a capability of a UE to perform uplink switching between an uplink band and a sidelink band, receive a grant scheduling an uplink message for transmission over a set of one or more transmit ports, switch a transmitter of the UE from the uplink band to the sidelink band based on the set of one or more transmit ports and the capability message, and transmit the uplink message using the sidelink band according to the grant and based on the switching.

Some examples of the method, apparatuses, and non-transitory computer-readable medium described herein may further include operations, features, means, or instructions for transmitting a feedback report associated with the grant over the sidelink band based on switching the transmitter of the UE, where the feedback report indicates that the switching was successful.

Some examples of the method, apparatuses, and non-transitory computer-readable medium described herein may further include operations, features, means, or instructions for transmitting a feedback report associated with the grant over the sidelink band based on switching the transmitter of the UE, where the feedback report indicates a conflict associated with the uplink message on the sidelink band.

Some examples of the method, apparatuses, and non-transitory computer-readable medium described herein may further include operations, features, means, or instructions for withholding a feedback report associated with the grant over the sidelink band based on a conflict associated with the uplink message on the sidelink band.

Some examples of the method, apparatuses, and non-transitory computer-readable medium described herein may further include operations, features, means, or instructions for reserving one or more future slots of the sidelink band for transmitting the uplink message based on the grant.

In some examples of the method, apparatuses, and non-transitory computer-readable medium described herein, the uplink message may be associated with a first radio access technology (RAT) and scheduled for resources associated with a second RAT on the sidelink band.

In some examples of the method, apparatuses, and non-transitory computer-readable medium described herein, the uplink message may be associated with a set of resources on the sidelink band that may be excluded from sidelink communications.

In some examples of the method, apparatuses, and non-transitory computer-readable medium described herein, transmitting the capability message may include operations, features, means, or instructions for transmitting, via the capability message, an indication that the UE may be capable of performing uplink transmissions using one or more of: the uplink band, the sidelink band, or the uplink band and the sidelink band simultaneously.

In some examples of the method, apparatuses, and non-transitory computer-readable medium described herein, transmitting the capability message may include operations, features, means, or instructions for transmitting, via the capability message, an indication of a quantity or set of timing advance groups (TAGs) supported by the UE for simultaneous transmissions over the uplink band and the sidelink band.

In some examples of the method, apparatuses, and non-transitory computer-readable medium described herein, up to two transmissions may be scheduled for the uplink band and the sidelink band.

In some examples of the method, apparatuses, and non-transitory computer-readable medium described herein, a switching gap between receiving the grant and transmitting the uplink message may be based on a switching period between bands in a same TAG and a defined maximum transmitted timing difference (MTTD).

A method for wireless communication is described. The method may include receiving a capability message indicating a capability of a UE to perform uplink switching between an uplink band and a sidelink band, transmitting a grant scheduling an uplink message for transmission over a set of one or more transmit ports, and receiving the uplink message using the sidelink band according to the grant and based on a transmitter of the UE switching from the uplink band to the sidelink band.

An apparatus for wireless communication is described. The apparatus may include a processor, memory in electronic communication with the processor, and instructions stored in the memory. The instructions may be executable by the processor to receive a capability message indicating a capability of a UE to perform uplink switching between an uplink band and a sidelink band, transmit a grant scheduling an uplink message for transmission over a set of one or more transmit ports, and receive the uplink message using the sidelink band according to the grant and based on a transmitter of the UE switching from the uplink band to the sidelink band.

Another apparatus for wireless communication is described. The apparatus may include means for receiving a capability message indicating a capability of a UE to perform uplink switching between an uplink band and a sidelink band, means for transmitting a grant scheduling an uplink message for transmission over a set of one or more transmit ports, and means for receiving the uplink message using the sidelink band according to the grant and based on a transmitter of the UE switching from the uplink band to the sidelink band.

A non-transitory computer-readable medium storing code for wireless communication at a network entity is described. The code may include instructions executable to receive a capability message indicating a capability of a UE to perform uplink switching between an uplink band and a sidelink band, transmit a grant scheduling an uplink message for transmission over a set of one or more transmit ports, and receive the uplink message using the sidelink band according to the grant and based on a transmitter of the UE switching from the uplink band to the sidelink band.

Some examples of the method, apparatuses, and non-transitory computer-readable medium described herein may further include operations, features, means, or instructions for receiving a feedback report associated with the grant over the sidelink band based on the transmitter of the UE switching, where the feedback report indicates that the switching was successful.

Some examples of the method, apparatuses, and non-transitory computer-readable medium described herein may further include operations, features, means, or instructions for receiving a feedback report associated with the grant over the sidelink band based on the transmitter of the UE switching, where the feedback report indicates a conflict associated with the uplink message on the sidelink band.

In some examples of the method, apparatuses, and non-transitory computer-readable medium described herein, receiving the uplink message may include operations, features, means, or instructions for receiving the uplink message via one or more future slots of the sidelink band based on the grant.

In some examples of the method, apparatuses, and non-transitory computer-readable medium described herein, the uplink message may be associated with a first RAT and scheduled for resources associated with a second RAT on the sidelink band.

In some examples of the method, apparatuses, and non-transitory computer-readable medium described herein, the uplink message may be associated with a set of resources on the sidelink band that may be excluded from sidelink communications.

In some examples of the method, apparatuses, and non-transitory computer-readable medium described herein, receiving the capability message may include operations, features, means, or instructions for receiving, via the capability message, an indication that the UE may be capable of performing uplink transmissions using one or more of the uplink band, the sidelink band, or the uplink band and the sidelink band simultaneously.

In some examples of the method, apparatuses, and non-transitory computer-readable medium described herein, receiving the capability message may include operations, features, means, or instructions for receiving, via the capability message, an indication of a quantity or set of TAGs supported by the UE for simultaneous transmissions over the uplink band and the sidelink band.

In some examples of the method, apparatuses, and non-transitory computer-readable medium described herein, up to two transmissions may be scheduled for the uplink band and the sidelink band.

In some examples of the method, apparatuses, and non-transitory computer-readable medium described herein, a switching gap between transmitting the grant and receiving the uplink message may be based on a switching period between bands in a same TAG and a defined MTTD.

### BRIEF DESCRIPTION OF THE DRAWINGS

FIG. 1 illustrates an example of a wireless communications system that supports uplink transmit switching for sidelink and uplink bands in accordance with one or more aspects of the present disclosure.

FIG. 2 illustrates an example of a wireless communications system that supports uplink transmit switching for sidelink and uplink bands in accordance with one or more aspects of the present disclosure.

FIG. 3 illustrates an example of a process flow that supports uplink transmit switching for sidelink and uplink bands in accordance with one or more aspects of the present disclosure.

FIGS. 4 and 5 show block diagrams of devices that support uplink transmit switching for sidelink and uplink bands in accordance with one or more aspects of the present disclosure.

FIG. 6 shows a block diagram of a communications manager that supports uplink transmit switching for sidelink and uplink bands in accordance with one or more aspects of the present disclosure.

FIG. 7 shows a diagram of a system including a device that supports uplink transmit switching for sidelink and uplink bands in accordance with one or more aspects of the present disclosure.

FIGS. 8 and 9 show block diagrams of devices that support uplink transmit switching for sidelink and uplink bands in accordance with one or more aspects of the present disclosure.

FIG. 10 shows a block diagram of a communications manager that supports uplink transmit switching for sidelink and uplink bands in accordance with one or more aspects of the present disclosure.

FIG. 11 shows a diagram of a system including a device that supports uplink transmit switching for sidelink and uplink bands in accordance with one or more aspects of the present disclosure.

FIGS. 12 through 17 show flowcharts illustrating methods that support uplink transmit switching for sidelink and uplink bands in accordance with one or more aspects of the present disclosure.

### DETAILED DESCRIPTION

In some wireless communications systems, a user equipment (UE) may perform uplink transmit switching between two bands to increase uplink signaling throughput and improve resource utilization. For example, the UE may switch between transmitting uplink messages on different frequency bands based on the type of data being transmitted. However, a UE may be unable to perform uplink switching from an uplink band to a sidelink band. For example, the UE may switch from transmitting an uplink message on an uplink band to a sidelink band. However, other transmissions may already be scheduled on the sidelink band at a same time, thus conflicting with the uplink transmission and resulting in dropped or failed transmissions. Additionally, without indicating whether the UE is to perform simultaneous transmissions using the uplink band and the sidelink band, the UE may underutilize resources on either or both bands, which may decrease signaling throughput.

The techniques described herein support performing uplink switching between an uplink band and a sidelink band, which may increase signaling throughput, spectral efficiency, and resource utilization. In some examples, the UE may transmit a capability message indicating a capability of the UE to perform uplink switching between an uplink band and a sidelink band. In some examples, the UE may be capable of communicating via the uplink band independently, the sidelink band independently, or the uplink band and the sidelink band simultaneously. The UE may receive a grant scheduling an uplink message transmission via a set of one or more transmit ports. If the UE is unable to transmit the uplink message using the transmit ports and the scheduled band, the UE may switch from transmitting using the uplink band to the sidelink band, and the UE may transmit the uplink message using the sidelink band accordingly.

Aspects of the disclosure are initially described in the context of wireless communications systems. Aspects of the disclosure are then described in the context of process flows. Aspects of the disclosure are further illustrated by and described with reference to apparatus diagrams, system diagrams, and flowcharts that relate to uplink transmit switching for sidelink and uplink bands.

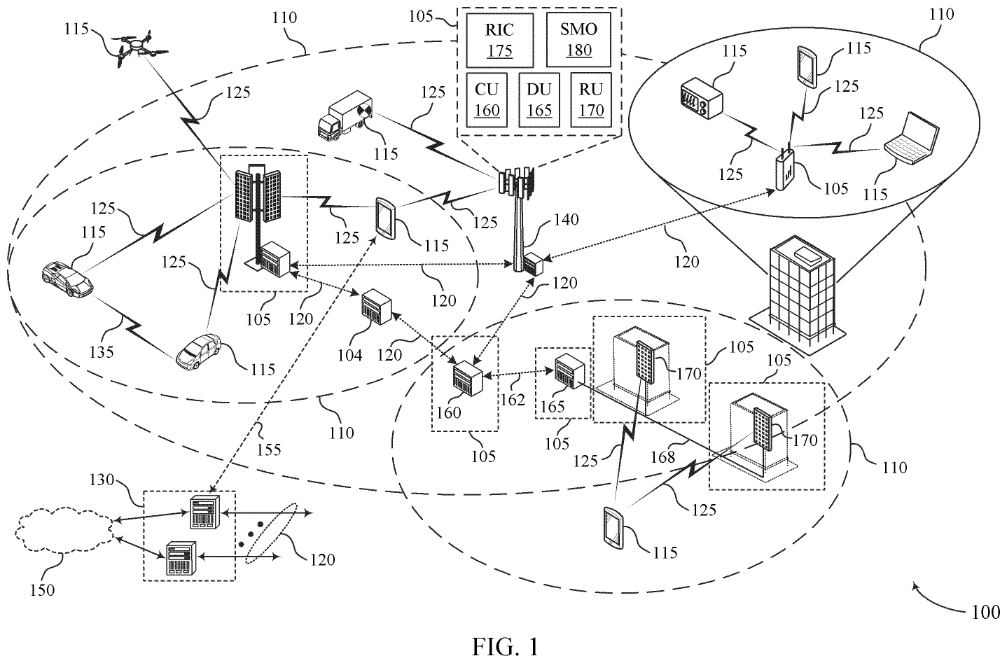

FIG. 1 illustrates an example of a wireless communications system 100 that supports uplink transmit switching for sidelink and uplink bands in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1,F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support uplink transmit switching for sidelink and uplink bands as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (RAT) (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting.” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrow band IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrow band communications), or a combination of these techniques. For example, some UEs 115 may be configured for operation using a narrow band protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, a UE 115 may perform uplink transmit switching between two bands, for example, two different frequency bands. In some cases, enabling the UE 115 to perform uplink transmit switching dynamically may increase uplink throughput. For example, if the UE 115 is able to use multiple bands to perform a transmission, the UE 115 may switch to a band that has less traffic or is associated with a high quality. In some cases, a UE 115 may perform uplink switching from an uplink band (e.g., a normal uplink band) to a sidelink band. To switch from the uplink band to the sidelink band in this way and increase uplink throughput, the UE 115 may schedule uplink messages on the uplink band and the sidelink band without conflicting with other transmissions, and in some cases, enable simultaneous transmissions via the uplink band and the sidelink band. For example, instead of receiving explicit signaling from a network entity 105 indicating to switch bands, the network entity 105 may schedule an uplink message transmission on the uplink band or the sidelink band, where the scheduling on a given band may trigger the switching if the UE 115 is unable to transmit the uplink message using a required transmit port number on the scheduled band. In some examples, the UE 115 may perform up to two transmissions using the uplink band and the sidelink band. Additionally, or alternatively, the network entity 105 may schedule no more than two transmissions using the uplink band and the sidelink band.

In some examples, the UE 115 may transmit a capability message indicating a capability of the UE 115 to perform uplink switching between an uplink band and a sidelink band. In some examples, the UE 115 may be capable of communicating via the uplink band independently, the sidelink band independently, or the uplink band and the sidelink band simultaneously. The UE 115 may receive a grant scheduling an uplink message transmission via a set of one or more transmit ports. If the UE 115 is unable to transmit the uplink message using the transmit ports and the scheduled band, the UE 115 may switch from transmitting using the uplink band to the sidelink band, and the UE 115 may transmit the uplink message using the sidelink band accordingly.

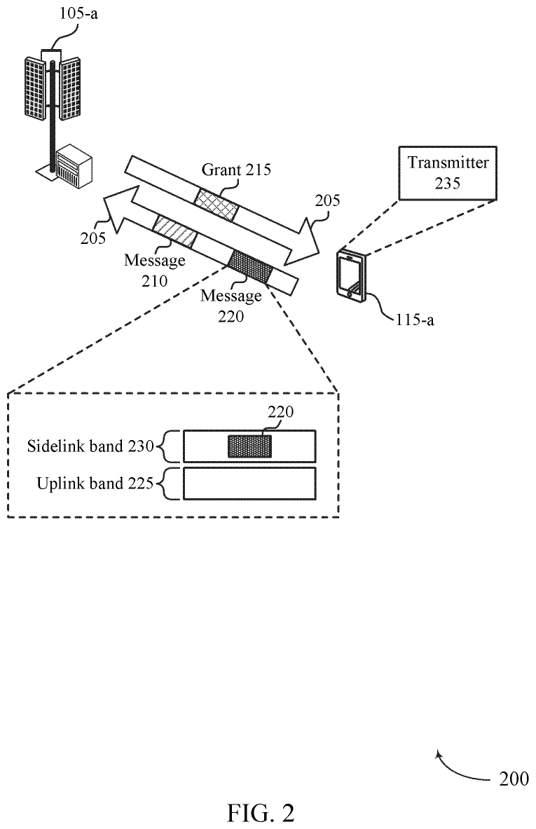

FIG. 2 illustrates an example of a wireless communications system 200 that supports uplink transmit switching for sidelink and uplink bands in accordance with one or more aspects of the present disclosure. In some examples, the wireless communications system 200 may implement aspects of the wireless communications system 100 or may be implemented by aspects of the wireless communications system 100. For example, the wireless communications system 200 may include a UE 115-a and a network entity 105-a, which may be examples of corresponding devices described herein. In some examples, the UE 115-a may support communications via an uplink band 225, a sidelink band 230, or both.

The wireless communications system 200 may support communications between the network entity 105-a and the UE 115-a. For example, the network entity 105-a may communicate signals (e.g., uplink and downlink transmissions) with the UE 115-a over respective communication links 205, which may be examples of communication links 125 described with reference to FIG. 1. In addition, the UE 115-a may communicate with the network entity 105-a via the uplink band 225, the sidelink band 230, or both.

The UE 115-a may be capable of performing uplink switching between the uplink band 225 and the sidelink band 230. In some examples, the UE 115-a may transmit a capability message 210 to the network entity 105-a indicating the capability of the UE 115-a. In addition, the capability message 210 may indicate a capability of the UE 115-a to perform uplink transmissions using one or more of the uplink band 225, the sidelink band 230, or the uplink band 225 and the sidelink band 230 simultaneously.

In some cases, the UE 115-a may receive a grant 215 (e.g., an uplink grant) from the network entity 105-a scheduling an uplink message 220 for transmission over a set of one or more transmit ports of the UE 115-a. For example, the network entity 105-a may schedule transmission of the uplink message 220 using the uplink band 225 and via one or more transmit ports. In some cases, the UE 115-a may be unable to transmit the uplink message 220 via the uplink band 225 using the required set of one or more transmit ports. For example, the UE 115-a may lack sufficient power to transmit the uplink message 220 using the uplink band 225 if the UE 115-a uses the set of one or more transmit ports indicated in the grant 215. As such, the UE 115-a may switch a transmitter 235 of the UE 115-a from the uplink band 225 to the sidelink band 230 based on the UE 115-a being capable of switching between the bands, and given that the UE 115-a is able to successfully transmit the uplink message 220 via the sidelink band 230 and using the set of one or more transmit ports indicated in the grant 215. Based on performing the switching, the UE 115-a may transmit the uplink message 220 to the network entity 105-a using the sidelink band 230.

In some cases, the UE 115-a and the network entity 105-a may operate according to a mode (e.g., sidelink Mode 2) in which the network entity 105-a schedules sidelink transmissions between the UE 115-a and other devices. In such cases, a set of resources may be reserved in the sidelink band 230 during which sidelink transmissions are not scheduled by the network entity 105-a, and the UE 115-a may make a transmission decision (e.g., determine to perform an uplink transmission using a particular band) based on the set of reserved resources. This may enable the UE 115-a to avoid scheduling conflicting uplink transmissions on the uplink band 225 and the sidelink band 230. For example, operating in Mode 2, the UE 115-a may reuse a physical uplink control channel (PUCCH) previously used for sidelink transmissions and retransmissions to transmit the uplink message 220 on the sidelink band 230, which may be based on the resources reserved in the sidelink band 230. T.

In some examples, the network entity 105-a may schedule the grant 215, and the UE 115-a may attempt to switch the transmitter 235 from the uplink band 225 to the sidelink band 230 accordingly. Based on the switching, the UE 115-a may transmit a PUCCH to the network entity 105-a that includes a feedback report. If the UE 115-a successfully switches the transmitter 235 from the uplink band 225 to the sidelink band 230, the feedback report may include an acknowledgment (ACK) message. That is, the UE 115-a may transmit a feedback report to the network entity 105-a associated with the grant over the sidelink band 230 based on switching the transmitter 235, where the feedback report indicates that the switching was successful (e.g., avoided conflict). Alternatively, if the UE 115-a detects a conflict associated with the uplink message 220 on the sidelink band 230 based on switching (e.g., if the UE 115-a fails to transmit the uplink message 220 via the sidelink band 230 because of another transmission already scheduled via the sidelink band 230 at the same time), the UE 115-a may report a negative acknowledgment (NACK). For example, the UE 115-a may transmit the feedback report associated the grant 215 over the sidelink band 230 based on switching the transmitter 235, where the feedback report indicates a conflict associated with the uplink message 220 on the sidelink band 230.

In some examples, instead of transmitting the NACK in the feedback report based on detecting the conflict, the UE 115-a may refrain from transmitting a feedback report, and the network entity 105-a may make a switching decision at a later time. That is, the UE 115-a may withhold a feedback report associated with the grant 215 over the sidelink band 230 based on the conflict associated with the uplink message 220 on the sidelink band 230. Additionally, or alternatively, the UE 115-a may reserve multiple future slots of the sidelink band 230 (e.g., a reservation window), during which the network entity 105-a may be unable to schedule the switching if the initial switching of the transmitter 235 from the uplink band 225 to the sidelink band 230 fails. That is, the UE 115-a may reserve one or more future slots of the sidelink band 230 for transmitting the uplink message 220 based on the grant 215, such that the UE 115-a effectively schedules the transmission of the uplink message 220 instead of the network entity 105-a.

In some cases, the wireless communications system 200 may support LTE and NR TDM coexistence. Based on the coexistence, the uplink message 220 may be associated with a first RAT (e.g., NR or LTE) and scheduled for resources associated with a second RAT (e.g., NR or LTE) on the sidelink band 230. For example, if the UE 115-a supports NR communications (e.g., an NR UE) and fails to report a capability of performing LTE sidelink communications, the network entity 105-a that supports NR communications (e.g., an NR base station) may use resources reserved for LTE sidelink communications for transmission of the uplink message 220 via the sidelink band 230. Alternatively, if the UE 115-a supports LTE communications (e.g., an LTE UE) and fails to report a capability of performing NR sidelink communications, the network entity 105-a that support LTE communications (e.g., an LTE base station) may use resources reserved for NR sidelink communications for the transmission of the uplink message 220 via the sidelink band 230.

Alternatively, to avoid conflict scheduling on the uplink band 225 and the sidelink band 230, the uplink message 220 may be associated with a set of resources on the sidelink band 230 that is excluded from sidelink communications. That is, the UE 115-a may use a resource with exclusion for performing uplink transmissions. In some examples, the set of resources excluded from sidelink communications may cover the entire sidelink band 230, and the set of resources (e.g., a reserved time slot or symbols) may be used for transmissions in other bands (e.g., the uplink band 225). If the set of excluded resources occurs in one or more subchannels (e.g., instead of across an entire bandwidth), the switching from the uplink band 225 to the sidelink band 230 may conflict with one or more scheduled sidelink transmissions on the sidelink band 230. In this way, the network entity 105-a may exclude some resources in particular frequencies to use for uplink transmissions, and as such, the UE 115-a may fail to reserve the excluded resources for sidelink transmissions.

As described herein, the UE 115-a may be capable of performing uplink transmissions using one or more of the uplink band 225, the sidelink band 230, or the uplink band 225 and the sidelink band 230 simultaneously. That is, the UE 115-a may be configured to perform one uplink transmission on one band at a time or simultaneous uplink transmissions on multiple bands. In some cases, the UE 115-a may be capable of performing simultaneous uplink transmissions on two bands (e.g., the uplink band 225 and the sidelink band 230) that are associated with a same timing advance group (TAG) or different TAGs. Accordingly, the UE 115-a may be capable of supporting multiple TAGs that may correspond to an uplink band group and a sidelink band group. As such, the UE 115-a may transmit an indication of a quantity or set of TAGs supported by the UE 115-a for simultaneous uplink transmissions over the uplink band 225 and the sidelink band 230 in the capability message 210.

In some examples, the UE 115-a and the network entity 105-a may operate according to a first mode (e.g., Mode 1), where the network entity 105-a may schedule uplink transmissions in one or more resources of the sidelink band 230. In some cases, the UE 115-a may avoid conflict scheduling on the uplink band 225 and the sidelink band 230 while operating in the first mode. If a sidelink network entity and an uplink network entity (e.g., a sidelink base station and an uplink base station associated with the network entity 105-a) are collocated, the network entity 105-a may be aware of the scheduling for the uplink band 225 and the sidelink band 230 and guarantee no conflict scheduling between the bands. For example, the network entity 105-a may schedule up to two transmissions using the uplink band 225 and the sidelink band 230 at the same time. That is, the network entity 105-a may institute a 3 transmit (Tx) violation where the network entity 105-a may schedule no more than two uplink transmissions using the uplink band 225 and the sidelink band 230.

If the sidelink network entity and the uplink network entity are non-collocated, the network entity 105-a may be aware of scheduling decisions of another cell (e.g., another network entity) with different TA values. For example, the network entity 105-a may know a TA associated with uplink transmissions scheduled via the sidelink band 230 without knowing actual timing information of those transmissions. Based on the TA values, the network entity 105-a may extend a switching gap (e.g., a time period during which the UE 115-a may switch from the uplink band 225 to the sidelink band 230) to a switching period having a same TAG and a same maximum transmitted timing difference (MTTD) (e.g., a maximum timing difference for the TAG), where the switching period may be long enough to enable the UE 115-a to successfully switch from the uplink band 225 to the sidelink band 230. That is, the network entity 105-a may configure a switching gap between a time the UE 115-a receives the grant 215 and transmits the uplink message 220 based on a switching period between the uplink band 225 and the sidelink band 230 in a same TAG and a defined MTTD. In this way, the network entity 105-a may schedule uplink transmissions via the uplink band 225 and the sidelink band 230 that avoid conflicts.

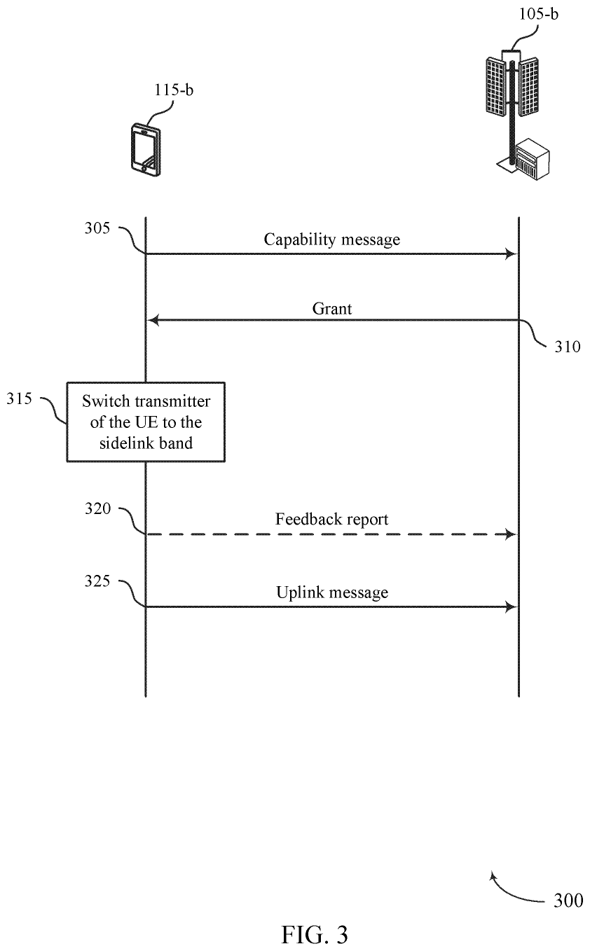

FIG. 3 illustrates an example of a process flow 300 that supports uplink transmit switching for sidelink and uplink bands in accordance with one or more aspects of the present disclosure. The process flow 300 may implement aspects of wireless communications systems 100 and 200, or may be implemented by aspects of the wireless communications systems 100 and 200. For example, the process flow 300 may illustrate operations between a UE 115-b and a network entity 105-b, which may be examples of corresponding devices described herein. In the following description of the process flow 300, the operations between the UE 115-b and the network entity 105-b may be transmitted in a different order than the example order shown, or the operations performed by the UE 115-b and the network entity 105-b may be performed in different orders or at different times. Some operations may also be omitted from the process flow 300, and other operations may be added to the process flow 300.

At 305, the UE 115-b may transmit, to the network entity 105-b, a capability message indicating a capability of the UE 115-b to perform uplink switching between an uplink band and a sidelink band. In some examples, the capability message may additionally indicate a capability of the UE 115-b to perform uplink transmissions on the uplink band, the sidelink band, or the uplink band and the sidelink band simultaneously. That is, the UE 115-b may be capable of performing simultaneous transmissions on the uplink band and the sidelink band, where no more than two uplink transmissions may be scheduled on the bands. The capability message 305 may include, for example, a UE capability information element transmitted to the network entity 105-b via RRC or other higher-layer signaling.

At 310, the UE 115-b may receive, from the network entity 105-b, a grant scheduling an uplink message for transmission over a set of one or more transmit ports of the UE 115-b. In some examples, the network entity 105-a may schedule the uplink message transmission on the uplink band.

At 315, the UE 115-b may switch a transmitter of the UE 115-b from the uplink band to the sidelink band based on the set of one or more transmit ports and the capability message. For example, if the UE 115-b is unable to transmit the uplink message on the uplink band (scheduled by the network entity 105-b) using the set of one or more transmit ports indicated in the grant, the UE 115-b may switch the transmitter to the sidelink band.

At 320, the UE 115-b may transmit, to the network entity 105-b, a feedback report associated with the grant over the sidelink band based on switching the transmitter of the UE 115-b. In some examples, the feedback report may include an ACK message indicating that the switching was successful. Alternatively, the feedback report may include a NACK message indicating that the switching was unsuccessful (e.g., switching the uplink message transmission to the sidelink band may conflict with another transmission already scheduled on the sidelink band). In some examples, the UE 115-b may withhold from transmitting any feedback report to the network entity 105-b if the switching was unsuccessful.

At 325, the UE 115-b may transmit, to the network entity 105-b, the uplink message using the sidelink band according to the grant and based on the switching. That is, based on switching the transmitter from the uplink band to the sidelink band, and if the UE 115-b is capable of performing the uplink transmission using the set of one or more transmit ports indicated in the grant on the sidelink band, the UE 115-b may transmit the uplink message accordingly.

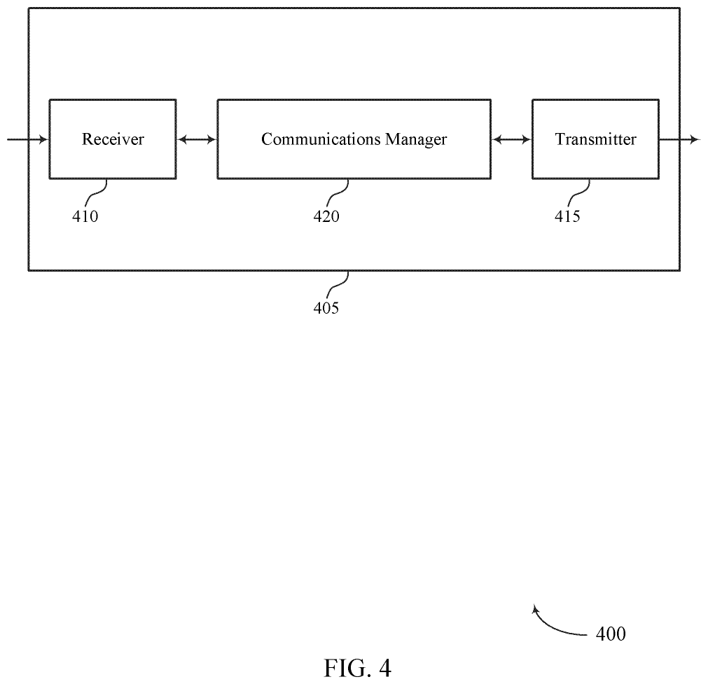

FIG. 4 shows a block diagram 400 of a device 405 that supports uplink transmit switching for sidelink and uplink bands in accordance with one or more aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to uplink transmit switching for sidelink and uplink bands). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to uplink transmit switching for sidelink and uplink bands). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of uplink transmit switching for sidelink and uplink bands as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication in accordance with examples as disclosed herein. For example, the communications manager 420 may be configured as or otherwise support a means for transmitting a capability message indicating a capability of a UE to perform uplink switching between an uplink band and a sidelink band. The communications manager 420 may be configured as or otherwise support a means for receiving a grant scheduling an uplink message for transmission over a set of one or more transmit ports. The communications manager 420 may be configured as or otherwise support a means for switching a transmitter of the UE from the uplink band to the sidelink band based on the set of one or more transmit ports and the capability message. The communications manager 420 may be configured as or otherwise support a means for transmitting the uplink message using the sidelink band according to the grant and based on the switching.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for uplink transmit switching between an uplink band and a sidelink band, which may increase signaling throughput, reduce latency, and provide for a more efficient utilization of communication resources.

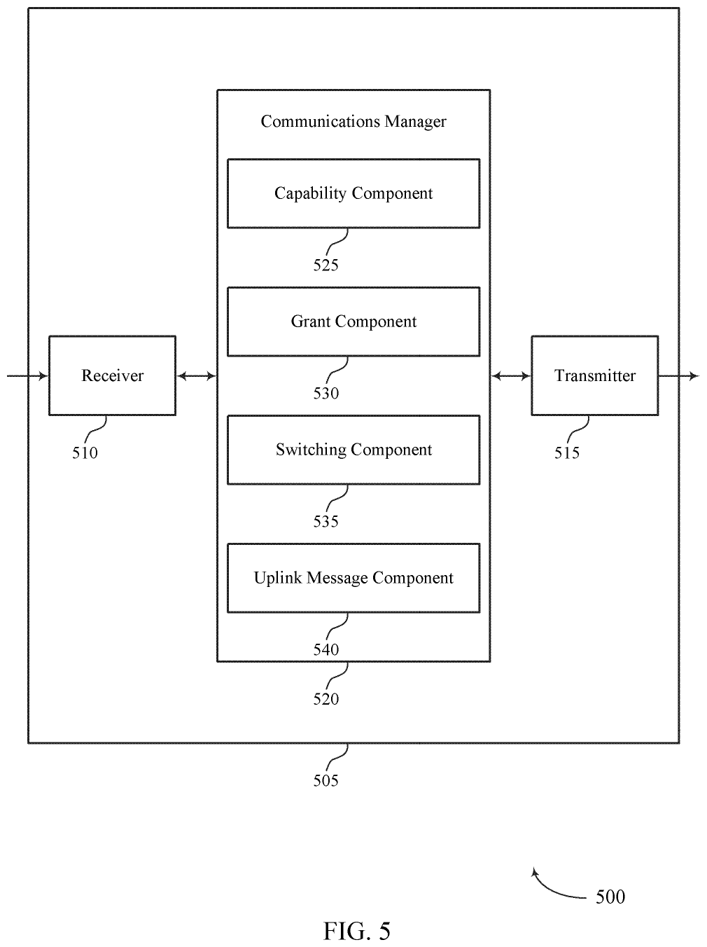

FIG. 5 shows a block diagram 500 of a device 505 that supports uplink transmit switching for sidelink and uplink bands in accordance with one or more aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to uplink transmit switching for sidelink and uplink bands). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to uplink transmit switching for sidelink and uplink bands). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of uplink transmit switching for sidelink and uplink bands as described herein. For example, the communications manager 520 may include a capability component 525, a grant component 530, a switching component 535, an uplink message component 540, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. The capability component 525 may be configured as or otherwise support a means for transmitting a capability message indicating a capability of a UE to perform uplink switching between an uplink band and a sidelink band. The grant component 530 may be configured as or otherwise support a means for receiving a grant scheduling an uplink message for transmission over a set of one or more transmit ports. The switching component 535 may be configured as or otherwise support a means for switching a transmitter of the UE from the uplink band to the sidelink band based on the set of one or more transmit ports and the capability message. The uplink message component 540 may be configured as or otherwise support a means for transmitting the uplink message using the sidelink band according to the grant and based on the switching.

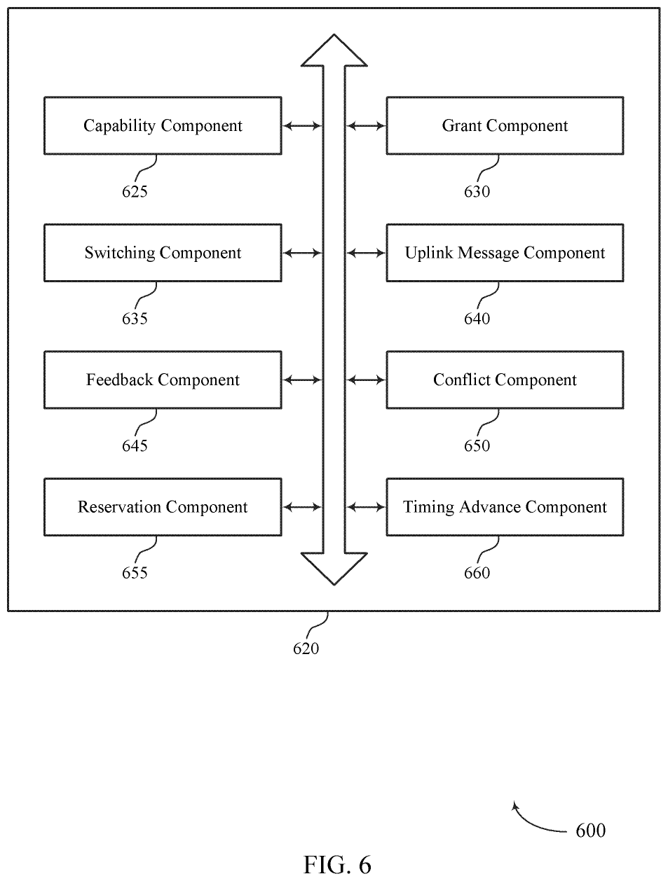

FIG. 6 shows a block diagram 600 of a communications manager 620 that supports uplink transmit switching for sidelink and uplink bands in accordance with one or more aspects of the present disclosure. The communications manager 620 may be an example of aspects of a communications manager 420, a communications manager 520, or both, as described herein. The communications manager 620, or various components thereof, may be an example of means for performing various aspects of uplink transmit switching for sidelink and uplink bands as described herein. For example, the communications manager 620 may include a capability component 625, a grant component 630, a switching component 635, an uplink message component 640, a feedback component 645, a conflict component 650, a reservation component 655, a TA component 660, or any combination thereof. Each of these components may communicate, directly or indirectly, with one another (e.g., via one or more buses).

The communications manager 620 may support wireless communication in accordance with examples as disclosed herein. The capability component 625 may be configured as or otherwise support a means for transmitting a capability message indicating a capability of a UE to perform uplink switching between an uplink band and a sidelink band. The grant component 630 may be configured as or otherwise support a means for receiving a grant scheduling an uplink message for transmission over a set of one or more transmit ports. The switching component 635 may be configured as or otherwise support a means for switching a transmitter of the UE from the uplink band to the sidelink band based on the set of one or more transmit ports and the capability message. The uplink message component 640 may be configured as or otherwise support a means for transmitting the uplink message using the sidelink band according to the grant and based on the switching.

In some examples, the feedback component 645 may be configured as or otherwise support a means for transmitting a feedback report associated with the grant over the sidelink band based on switching the transmitter of the UE, where the feedback report indicates that the switching was successful.

In some examples, the feedback component 645 may be configured as or otherwise support a means for transmitting a feedback report associated with the grant over the sidelink band based on switching the transmitter of the UE, where the feedback report indicates a conflict associated with the uplink message on the sidelink band.

In some examples, the conflict component 650 may be configured as or otherwise support a means for withholding a feedback report associated with the grant over the sidelink band based on a conflict associated with the uplink message on the sidelink band.

In some examples, the reservation component 655 may be configured as or otherwise support a means for reserving one or more future slots of the sidelink band for transmitting the uplink message based on the grant.

In some examples, the uplink message is associated with a first RAT and scheduled for resources associated with a second RAT on the sidelink band. In some examples, the uplink message is associated with a set of resources on the sidelink band that is excluded from sidelink communications.

In some examples, to support transmitting the capability message, the capability component 625 may be configured as or otherwise support a means for transmitting, via the capability message, an indication that the UE is capable of performing uplink transmissions using one or more of: the uplink band, the sidelink band, or the uplink band and the sidelink band simultaneously.

In some examples, to support transmitting the capability message, the TA component 660 may be configured as or otherwise support a means for transmitting, via the capability message, an indication of a quantity or set of TAGs supported by the UE for simultaneous transmissions over the uplink band and the sidelink band.

In some examples, up to two transmissions are scheduled for the uplink band and the sidelink band. In some examples, a switching gap between receiving the grant and transmitting the uplink message is based on a switching period between bands in a same TAG and a defined MTTD.

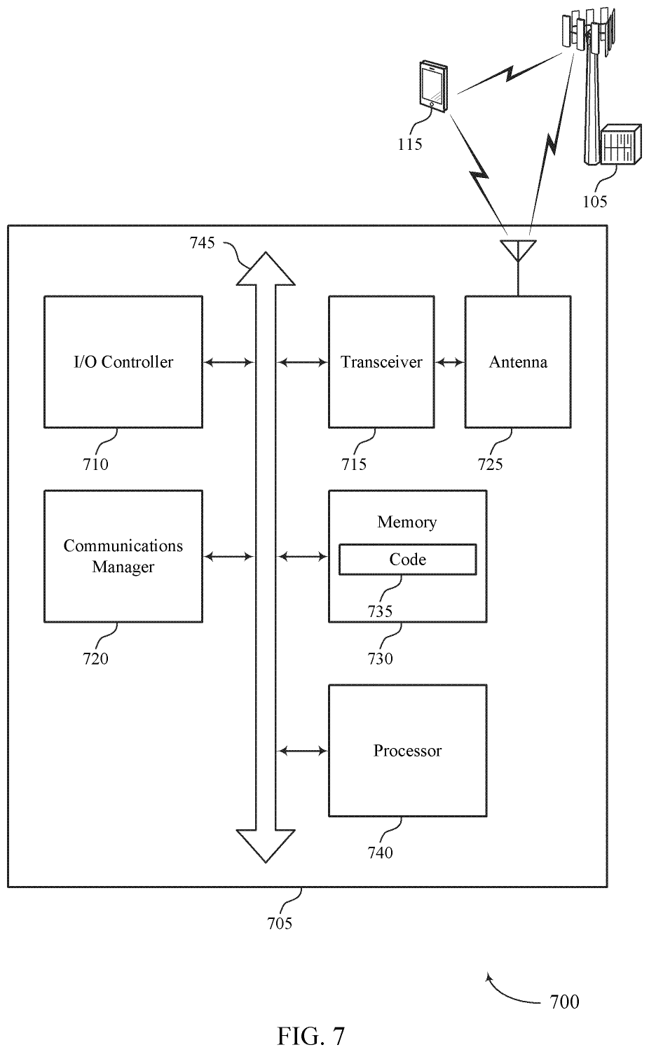

FIG. 7 shows a diagram of a system 700 including a device 705 that supports uplink transmit switching for sidelink and uplink bands in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®), UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting uplink transmit switching for sidelink and uplink bands). For example, the device 705 or a component of the device 705 may include a processor 740 and memory 730 coupled with or to the processor 740, the processor 740 and memory 730 configured to perform various functions described herein.

The communications manager 720 may support wireless communication in accordance with examples as disclosed herein. For example, the communications manager 720 may be configured as or otherwise support a means for transmitting a capability message indicating a capability of a UE to perform uplink switching between an uplink band and a sidelink band. The communications manager 720 may be configured as or otherwise support a means for receiving a grant scheduling an uplink message for transmission over a set of one or more transmit ports. The communications manager 720 may be configured as or otherwise support a means for switching a transmitter of the UE from the uplink band to the sidelink band based on the set of one or more transmit ports and the capability message. The communications manager 720 may be configured as or otherwise support a means for transmitting the uplink message using the sidelink band according to the grant and based on the switching.

By including or configuring the communications manager 720 in accordance with examples as described herein, the device 705 may support techniques for uplink transmit switching between an uplink band and a sidelink band, which may increase signaling throughput, reduce latency, and provide for a more efficient utilization of communication resources.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of uplink transmit switching for sidelink and uplink bands as described herein, or the processor 740 and the memory 730 may be otherwise configured to perform or support such operations.

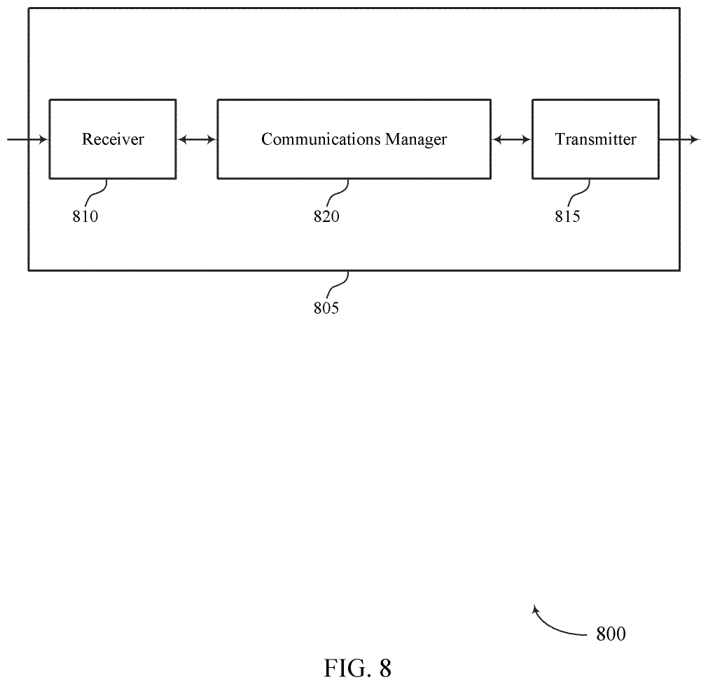

FIG. 8 shows a block diagram 800 of a device 805 that supports uplink transmit switching for sidelink and uplink bands in accordance with one or more aspects of the present disclosure. The device 805 may be an example of aspects of a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of uplink transmit switching for sidelink and uplink bands as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication in accordance with examples as disclosed herein. For example, the communications manager 820 may be configured as or otherwise support a means for receiving a capability message indicating a capability of a UE to perform uplink switching between an uplink band and a sidelink band. The communications manager 820 may be configured as or otherwise support a means for transmitting a grant scheduling an uplink message for transmission over a set of one or more transmit ports. The communications manager 820 may be configured as or otherwise support a means for receiving the uplink message using the sidelink band according to the grant and based on a transmitter of the UE switching from the uplink band to the sidelink band.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for uplink transmit switching between an uplink band and a sidelink band, which may increase signaling throughput, reduce latency, and provide for a more efficient utilization of communication resources.

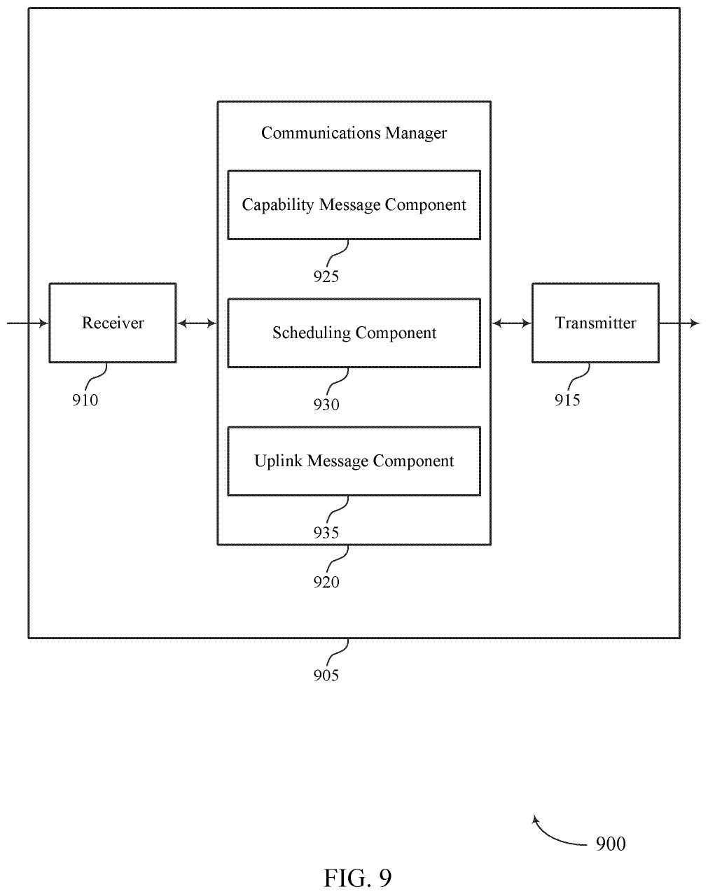

FIG. 9 shows a block diagram 900 of a device 905 that supports uplink transmit switching for sidelink and uplink bands in accordance with one or more aspects of the present disclosure. The device 905 may be an example of aspects of a device 805 or a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of uplink transmit switching for sidelink and uplink bands as described herein. For example, the communications manager 920 may include a capability message component 925, a scheduling component 930, an uplink message component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication in accordance with examples as disclosed herein. The capability message component 925 may be configured as or otherwise support a means for receiving a capability message indicating a capability of a UE to perform uplink switching between an uplink band and a sidelink band. The scheduling component 930 may be configured as or otherwise support a means for transmitting a grant scheduling an uplink message for transmission over a set of one or more transmit ports. The uplink message component 935 may be configured as or otherwise support a means for receiving the uplink message using the sidelink band according to the grant and based on a transmitter of the UE switching from the uplink band to the sidelink band.

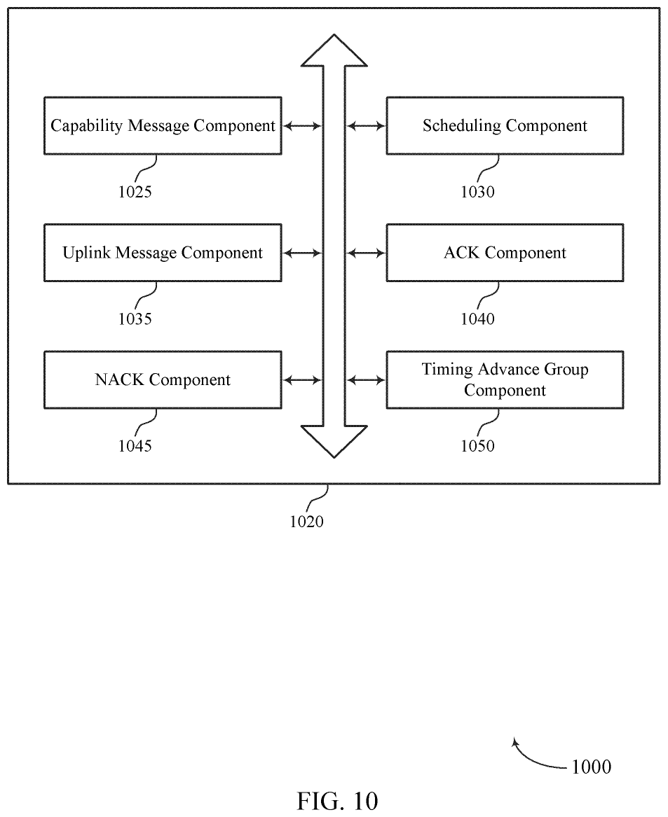

FIG. 10 shows a block diagram 1000 of a communications manager 1020 that supports uplink transmit switching for sidelink and uplink bands in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of uplink transmit switching for sidelink and uplink bands as described herein. For example, the communications manager 1020 may include a capability message component 1025, a scheduling component 1030, an uplink message component 1035, an ACK component 1040, a NACK component 1045, a TAG component 1050, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communication in accordance with examples as disclosed herein. The capability message component 1025 may be configured as or otherwise support a means for receiving a capability message indicating a capability of a UE to perform uplink switching between an uplink band and a sidelink band. The scheduling component 1030 may be configured as or otherwise support a means for transmitting a grant scheduling an uplink message for transmission over a set of one or more transmit ports. The uplink message component 1035 may be configured as or otherwise support a means for receiving the uplink message using the sidelink band according to the grant and based on a transmitter of the UE switching from the uplink band to the sidelink band.

In some examples, the ACK component 1040 may be configured as or otherwise support a means for receiving a feedback report associated with the grant over the sidelink band based on the transmitter of the UE switching, where the feedback report indicates that the switching was successful.

In some examples, the NACK component 1045 may be configured as or otherwise support a means for receiving a feedback report associated with the grant over the sidelink band based on the transmitter of the UE switching, where the feedback report indicates a conflict associated with the uplink message on the sidelink band.

In some examples, to support receiving the uplink message, the uplink message component 1035 may be configured as or otherwise support a means for receiving the uplink message via one or more future slots of the sidelink band based on the grant.

In some examples, the uplink message is associated with a first RAT and scheduled for resources associated with a second RAT on the sidelink band. In some examples, the uplink message is associated with a set of resources on the sidelink band that is excluded from sidelink communications.

In some examples, to support receiving the capability message, the TAG component 1050 may be configured as or otherwise support a means for receiving, via the capability message, an indication that the UE is capable of performing uplink transmissions using one or more of the uplink band, the sidelink band, or the uplink band and the sidelink band simultaneously.

In some examples, to support receiving the capability message, the TAG component 1050 may be configured as or otherwise support a means for receiving, via the capability message, an indication of a quantity or set of TAGs supported by the UE for simultaneous transmissions over the uplink band and the sidelink band.

In some examples, up to two transmissions are scheduled for the uplink band and the sidelink band. In some examples, a switching gap between transmitting the grant and receiving the uplink message is based on a switching period between bands in a same TAG and a defined MTTD.

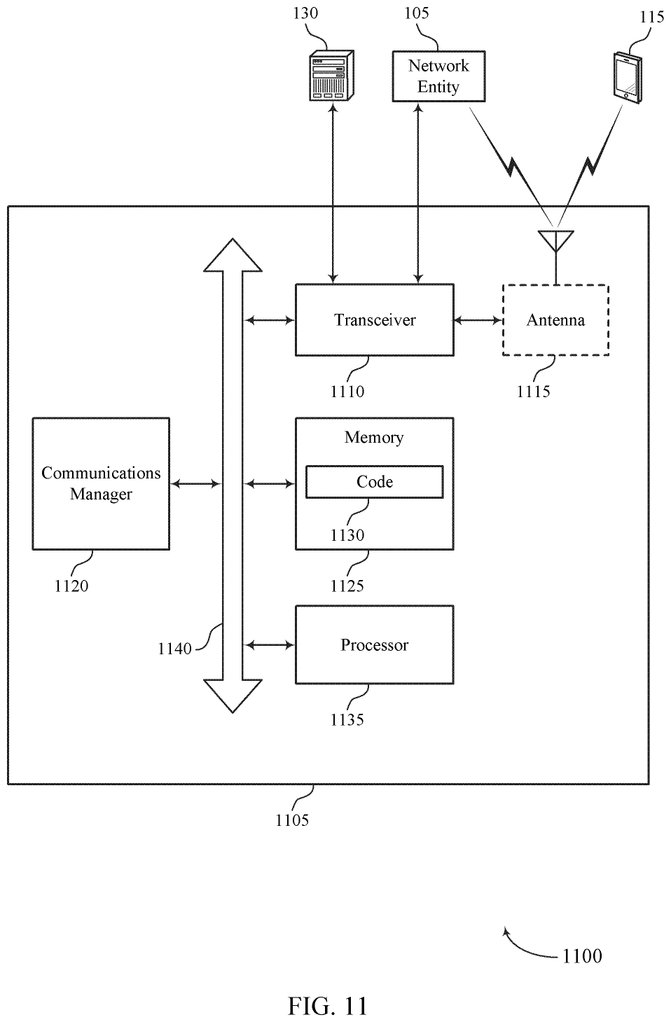

FIG. 11 shows a diagram of a system 1100 including a device 1105 that supports uplink transmit switching for sidelink and uplink bands in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or memory components (for example, the processor 1135, or the memory 1125, or both), may be included in a chip or chip assembly that is installed in the device 1105. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting uplink transmit switching for sidelink and uplink bands). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105. The processor 1135 may be any one or more suitable processors capable of executing scripts or instructions of one or more software programs stored in the device 1105 (such as within the memory 1125). In some implementations, the processor 1135 may be a component of a processing system. A processing system may generally refer to a system or series of machines or components that receives inputs and processes the inputs to produce a set of outputs (which may be passed to other systems or components of, for example, the device 1105). For example, a processing system of the device 1105 may refer to a system including the various other components or subcomponents of the device 1105, such as the processor 1135, or the transceiver 1110, or the communications manager 1120, or other components or combinations of components of the device 1105. The processing system of the device 1105 may interface with other components of the device 1105, and may process information received from other components (such as inputs or signals) or output information to other components. For example, a chip or modem of the device 1105 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1105 may transmit information output from the chip or modem. Additionally, or alternatively, in some implementations, the one or more interfaces may refer to an interface between the processing system of the chip or modem and a receiver, such that the device 1105 may obtain information or signal inputs, and the information may be passed to the processing system. A person having ordinary skill in the art will readily recognize that a first interface also may obtain information or signal inputs, and a second interface also may output information or signal outputs.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communication in accordance with examples as disclosed herein. For example, the communications manager 1120 may be configured as or otherwise support a means for receiving a capability message indicating a capability of a UE to perform uplink switching between an uplink band and a sidelink band. The communications manager 1120 may be configured as or otherwise support a means for transmitting a grant scheduling an uplink message for transmission over a set of one or more transmit ports. The communications manager 1120 may be configured as or otherwise support a means for receiving the uplink message using the sidelink band according to the grant and based on a transmitter of the UE switching from the uplink band to the sidelink band.

By including or configuring the communications manager 1120 in accordance with examples as described herein, the device 1105 may support techniques for uplink transmit switching between an uplink band and a sidelink band, which may increase signaling throughput, reduce latency, and provide for a more efficient utilization of communication resources.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, the processor 1135, the memory 1125, the code 1130, or any combination thereof. For example, the code 1130 may include instructions executable by the processor 1135 to cause the device 1105 to perform various aspects of uplink transmit switching for sidelink and uplink bands as described herein, or the processor 1135 and the memory 1125 may be otherwise configured to perform or support such operations.

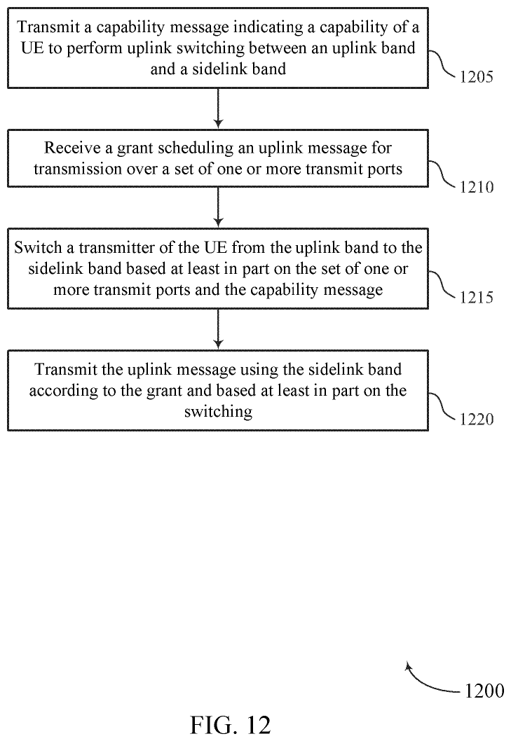

FIG. 12 shows a flowchart illustrating a method 1200 that supports uplink transmit switching for sidelink and uplink bands in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include transmitting a capability message indicating a capability of a UE to perform uplink switching between an uplink band and a sidelink band. The operations of 1205 may be performed in accordance with examples as disclosed herein. In some examples, aspects of the operations of 1205 may be performed by a capability component 625 as described with reference to FIG. 6.

At 1210, the method may include receiving a grant scheduling an uplink message for transmission over a set of one or more transmit ports. The operations of 1210 may be performed in accordance with examples as disclosed herein. In some examples, aspects of the operations of 1210 may be performed by a grant component 630 as described with reference to FIG. 6.

At 1215, the method may include switching a transmitter of the UE from the uplink band to the sidelink band based on the set of one or more transmit ports and the capability message. The operations of 1215 may be performed in accordance with examples as disclosed herein. In some examples, aspects of the operations of 1215 may be performed by a switching component 635 as described with reference to FIG. 6.

At 1220, the method may include transmitting the uplink message using the sidelink band according to the grant and based on the switching. The operations of 1220 may be performed in accordance with examples as disclosed herein. In some examples, aspects of the operations of 1220 may be performed by an uplink message component 640 as described with reference to FIG. 6.

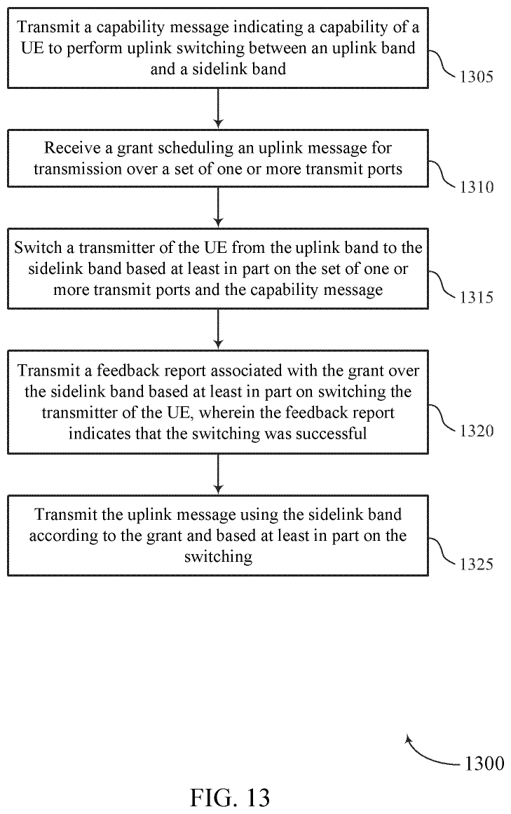

FIG. 13 shows a flowchart illustrating a method 1300 that supports uplink transmit switching for sidelink and uplink bands in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include transmitting a capability message indicating a capability of a UE to perform uplink switching between an uplink band and a sidelink band. The operations of 1305 may be performed in accordance with examples as disclosed herein. In some examples, aspects of the operations of 1305 may be performed by a capability component 625 as described with reference to FIG. 6.

At 1310, the method may include receiving a grant scheduling an uplink message for transmission over a set of one or more transmit ports. The operations of 1310 may be performed in accordance with examples as disclosed herein. In some examples, aspects of the operations of 1310 may be performed by a grant component 630 as described with reference to FIG. 6.

At 1315, the method may include switching a transmitter of the UE from the uplink band to the sidelink band based on the set of one or more transmit ports and the capability message. The operations of 1315 may be performed in accordance with examples as disclosed herein. In some examples, aspects of the operations of 1315 may be performed by a switching component 635 as described with reference to FIG. 6.

At 1320, the method may include transmitting a feedback report associated with the grant over the sidelink band based on switching the transmitter of the UE, where the feedback report indicates that the switching was successful. The operations of 1320 may be performed in accordance with examples as disclosed herein. In some examples, aspects of the operations of 1320 may be performed by a feedback component 645 as described with reference to FIG. 6.

At 1325, the method may include transmitting the uplink message using the sidelink band according to the grant and based on the switching. The operations of 1325 may be performed in accordance with examples as disclosed herein. In some examples, aspects of the operations of 1325 may be performed by an uplink message component 640 as described with reference to FIG. 6.

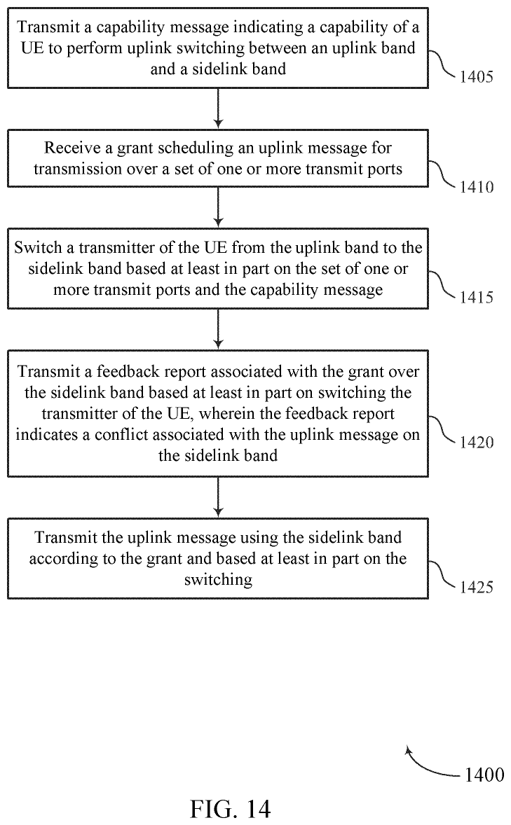

FIG. 14 shows a flowchart illustrating a method 1400 that supports uplink transmit switching for sidelink and uplink bands in accordance with one or more aspects of the present disclosure. The operations of the method 1400 may be implemented by a UE or its components as described herein. For example, the operations of the method 1400 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1405, the method may include transmitting a capability message indicating a capability of a UE to perform uplink switching between an uplink band and a sidelink band. The operations of 1405 may be performed in accordance with examples as disclosed herein. In some examples, aspects of the operations of 1405 may be performed by a capability component 625 as described with reference to FIG. 6.

At 1410, the method may include receiving a grant scheduling an uplink message for transmission over a set of one or more transmit ports. The operations of 1410 may be performed in accordance with examples as disclosed herein. In some examples, aspects of the operations of 1410 may be performed by a grant component 630 as described with reference to FIG. 6.

At 1415, the method may include switching a transmitter of the UE from the uplink band to the sidelink band based on the set of one or more transmit ports and the capability message. The operations of 1415 may be performed in accordance with examples as disclosed herein. In some examples, aspects of the operations of 1415 may be performed by a switching component 635 as described with reference to FIG. 6.

At 1420, the method may include transmitting a feedback report associated with the grant over the sidelink band based on switching the transmitter of the UE, where the feedback report indicates a conflict associated with the uplink message on the sidelink band. The operations of 1420 may be performed in accordance with examples as disclosed herein. In some examples, aspects of the operations of 1420 may be performed by a feedback component 645 as described with reference to FIG. 6.

At 1425, the method may include transmitting the uplink message using the sidelink band according to the grant and based on the switching. The operations of 1425 may be performed in accordance with examples as disclosed herein. In some examples, aspects of the operations of 1425 may be performed by an uplink message component 640 as described with reference to FIG. 6.

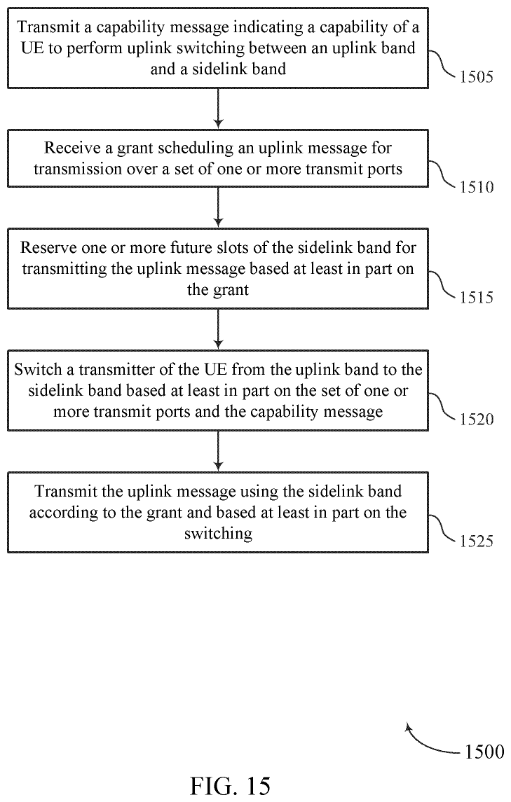

FIG. 15 shows a flowchart illustrating a method 1500 that supports uplink transmit switching for sidelink and uplink bands in accordance with one or more aspects of the present disclosure. The operations of the method 1500 may be implemented by a UE or its components as described herein. For example, the operations of the method 1500 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1505, the method may include transmitting a capability message indicating a capability of a UE to perform uplink switching between an uplink band and a sidelink band. The operations of 1505 may be performed in accordance with examples as disclosed herein. In some examples, aspects of the operations of 1505 may be performed by a capability component 625 as described with reference to FIG. 6.

At 1510, the method may include receiving a grant scheduling an uplink message for transmission over a set of one or more transmit ports. The operations of 1510 may be performed in accordance with examples as disclosed herein. In some examples, aspects of the operations of 1510 may be performed by a grant component 630 as described with reference to FIG. 6.

At 1515, the method may include reserving one or more future slots of the sidelink band for transmitting the uplink message based on the grant. The operations of 1515 may be performed in accordance with examples as disclosed herein. In some examples, aspects of the operations of 1515 may be performed by a reservation component 655 as described with reference to FIG. 6.

At 1520, the method may include switching a transmitter of the UE from the uplink band to the sidelink band based on the set of one or more transmit ports and the capability message. The operations of 1520 may be performed in accordance with examples as disclosed herein. In some examples, aspects of the operations of 1520 may be performed by a switching component 635 as described with reference to FIG. 6.

At 1525, the method may include transmitting the uplink message using the sidelink band according to the grant and based on the switching. The operations of 1525 may be performed in accordance with examples as disclosed herein. In some examples, aspects of the operations of 1525 may be performed by an uplink message component 640 as described with reference to FIG. 6.

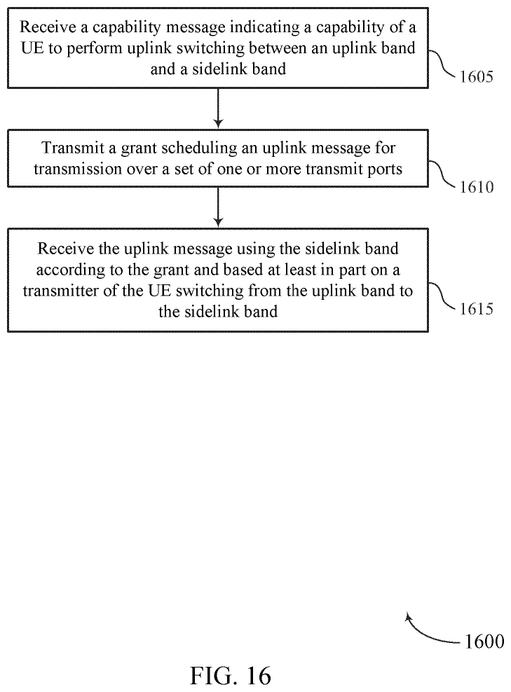

FIG. 16 shows a flowchart illustrating a method 1600 that supports uplink transmit switching for sidelink and uplink bands in accordance with one or more aspects of the present disclosure. The operations of the method 1600 may be implemented by a network entity or its components as described herein. For example, the operations of the method 1600 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1605, the method may include receiving a capability message indicating a capability of a UE to perform uplink switching between an uplink band and a sidelink band. The operations of 1605 may be performed in accordance with examples as disclosed herein. In some examples, aspects of the operations of 1605 may be performed by a capability message component 1025 as described with reference to FIG. 10.

At 1610, the method may include transmitting a grant scheduling an uplink message for transmission over a set of one or more transmit ports. The operations of 1610 may be performed in accordance with examples as disclosed herein. In some examples, aspects of the operations of 1610 may be performed by a scheduling component 1030 as described with reference to FIG. 10.

At 1615, the method may include receiving the uplink message using the sidelink band according to the grant and based on a transmitter of the UE switching from the uplink band to the sidelink band. The operations of 1615 may be performed in accordance with examples as disclosed herein. In some examples, aspects of the operations of 1615 may be performed by an uplink message component 1035 as described with reference to FIG. 10.

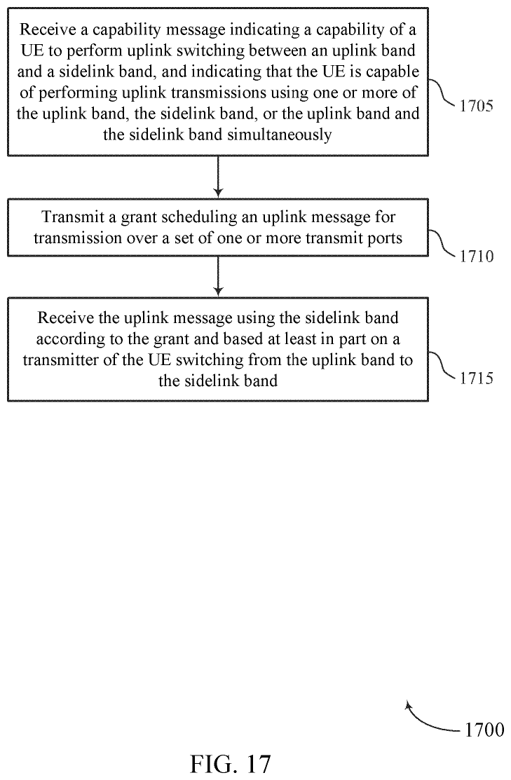

FIG. 17 shows a flowchart illustrating a method 1700 that supports uplink transmit switching for sidelink and uplink bands in accordance with one or more aspects of the present disclosure. The operations of the method 1700 may be implemented by a network entity or its components as described herein. For example, the operations of the method 1700 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1705, the method may include receiving a capability message indicating a capability of a UE to perform uplink switching between an uplink band and a sidelink band, and indicating that the UE is capable of performing uplink transmissions using one or more of the uplink band, the sidelink band, or the uplink band and the sidelink band simultaneously. The operations of 1705 may be performed in accordance with examples as disclosed herein. In some examples, aspects of the operations of 1705 may be performed by a capability message component 1025 as described with reference to FIG. 10.

At 1710, the method may include transmitting a grant scheduling an uplink message for transmission over a set of one or more transmit ports. The operations of 1710 may be performed in accordance with examples as disclosed herein. In some examples, aspects of the operations of 1710 may be performed by a scheduling component 1030 as described with reference to FIG. 10.

At 1715, the method may include receiving the uplink message using the sidelink band according to the grant and based on a transmitter of the UE switching from the uplink band to the sidelink band. The operations of 1715 may be performed in accordance with examples as disclosed herein. In some examples, aspects of the operations of 1715 may be performed by an uplink message component 1035 as described with reference to FIG. 10.

The following provides an overview of aspects of the present disclosure:

Aspect 1: A method for wireless communication, comprising: transmitting a capability message indicating a capability of a UE to perform uplink switching between an uplink band and a sidelink band: receiving a grant scheduling an uplink message for transmission over a set of one or more transmit ports: switching a transmitter of the UE from the uplink band to the sidelink band based at least in part on the set of one or more transmit ports and the capability message: and transmitting the uplink message using the sidelink band according to the grant and based at least in part on the switching.

Aspect 2: The method of aspect 1, further comprising: transmitting a feedback report associated with the grant over the sidelink band based at least in part on switching the transmitter of the UE, wherein the feedback report indicates that the switching was successful.

Aspect 3: The method of any of aspects 1 through 2, further comprising: transmitting a feedback report associated with the grant over the sidelink band based at least in part on switching the transmitter of the UE, wherein the feedback report indicates a conflict associated with the uplink message on the sidelink band.

Aspect 4: The method of any of aspects 1 through 3, further comprising: withholding a feedback report associated with the grant over the sidelink band based at least in part on a conflict associated with the uplink message on the sidelink band.

Aspect 5: The method of any of aspects 1 through 4, further comprising: reserving one or more future slots of the sidelink band for transmitting the uplink message based at least in part on the grant.

Aspect 6: The method of any of aspects 1 through 5, wherein the uplink message is associated with a first radio access technology and scheduled for resources associated with a second radio access technology on the sidelink band.

Aspect 7: The method of any of aspects 1 through 6, wherein the uplink message is associated with a set of resources on the sidelink band that is excluded from sidelink communications.

Aspect 8: The method of any of aspects 1 through 7, wherein transmitting the capability message comprises: transmitting, via the capability message, an indication that the UE is capable of performing uplink transmissions using one or more of: the uplink band, the sidelink band, or the uplink band and the sidelink band simultaneously.

Aspect 9: The method of aspect 8, wherein transmitting the capability message comprises: transmitting, via the capability message, an indication of a quantity or set of TAGs supported by the UE for simultaneous transmissions over the uplink band and the sidelink band.

Aspect 10: The method of any of aspects 1 through 9, further comprising: up to two transmissions are scheduled for the uplink band and the sidelink band.

Aspect 11: The method of any of aspects 1 through 10, wherein a switching gap between receiving the grant and transmitting the uplink message is based at least in part on a switching period between bands in a same TAG and a defined MTTD.

Aspect 12: A method for wireless communication, comprising: receiving a capability message indicating a capability of a UE to perform uplink switching between an uplink band and a sidelink band: transmitting a grant scheduling an uplink message for transmission over a set of one or more transmit ports; and receiving the uplink message using the sidelink band according to the grant and based at least in part on a transmitter of the UE switching from the uplink band to the sidelink band.

Aspect 13: The method of aspect 12, further comprising: receiving a feedback report associated with the grant over the sidelink band based at least in part on the transmitter of the UE switching, wherein the feedback report indicates that the switching was successful.

Aspect 14: The method of any of aspects 12 through 13, further comprising: receiving a feedback report associated with the grant over the sidelink band based at least in part on the transmitter of the UE switching, wherein the feedback report indicates a conflict associated with the uplink message on the sidelink band.

Aspect 15: The method of any of aspects 12 through 14, wherein receiving the uplink message comprises: receiving the uplink message via one or more future slots of the sidelink band based at least in part on the grant.

Aspect 16: The method of any of aspects 12 through 15, wherein the uplink message is associated with a first radio access technology and scheduled for resources associated with a second radio access technology on the sidelink band.

Aspect 17: The method of any of aspects 12 through 16, wherein the uplink message is associated with a set of resources on the sidelink band that is excluded from sidelink communications.

Aspect 18: The method of any of aspects 12 through 17, wherein receiving the capability message comprises: receiving, via the capability message, an indication that the UE is capable of performing uplink transmissions using one or more of the uplink band, the sidelink band, or the uplink band and the sidelink band simultaneously.

Aspect 19: The method of aspect 18, wherein receiving the capability message comprises: receiving, via the capability message, an indication of a quantity or set of TAGs supported by the UE for simultaneous transmissions over the uplink band and the sidelink band.

Aspect 20: The method of any of aspects 12 through 19, further comprising: up to two transmissions are scheduled for the uplink band and the sidelink band.

Aspect 21: The method of any of aspects 12 through 20, wherein a switching gap between transmitting the grant and receiving the uplink message is based at least in part on a switching period between bands in a same TAG and a defined MTTD.

Aspect 22: An apparatus for wireless communication, comprising a processor: memory in electronic communication with the processor; and instructions stored in the memory, wherein the instructions are executable by the processor to perform a method of any of aspects 1 through 11.

Aspect 23: An apparatus for wireless communication, comprising at least one means for performing a method of any of aspects 1 through 11.

Aspect 24: A non-transitory computer-readable medium storing code for wireless communication at a UE, the code comprising instructions executable to perform a method of any of aspects 1 through 11.

Aspect 25: An apparatus for wireless communication, comprising a processor: memory in electronic communication with the processor: and instructions stored in the memory, wherein the instructions are executable by the processor to perform a method of any of aspects 12 through 21.

Aspect 26: An apparatus for wireless communication, comprising at least one means for performing a method of any of aspects 12 through 21.

Aspect 27: A non-transitory computer-readable medium storing code for wireless communication at a UE, the code comprising instructions executable to perform a method of any of aspects 12 through 21.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication, comprising:
a processor:
memory in electronic communication with the processor; and
instructions stored in the memory, wherein the instructions are executable by the processor to:
transmit a capability message indicating a capability of a UE to perform uplink switching between an uplink band and a sidelink band;
receive a grant scheduling an uplink message for transmission over a set of one or more transmit ports:
switch a transmitter of the UE from the uplink band to the sidelink band based at least in part on the set of one or more transmit ports and the capability message: and
transmit the uplink message using the sidelink band according to the grant and based at least in part on the switching.

2. The apparatus of claim 1, wherein the instructions are further executable by the processor to:
transmit a feedback report associated with the grant over the sidelink band based at least in part on switching the transmitter of the UE, wherein the feedback report indicates that the switching was successful.

3. The apparatus of claim 1, wherein the instructions are further executable by the processor to:
transmit a feedback report associated with the grant over the sidelink band based at least in part on switching the transmitter of the UE, wherein the feedback report indicates a conflict associated with the uplink message on the sidelink band.

4. The apparatus of claim 1, wherein the instructions are further executable by the processor to:
withhold a feedback report associated with the grant over the sidelink band based at least in part on a conflict associated with the uplink message on the sidelink band.

5. The apparatus of claim 1, wherein the instructions are further executable by the processor to:
reserve one or more future slots of the sidelink band for transmitting the uplink message based at least in part on the grant.

6. The apparatus of claim 1, wherein the uplink message is associated with a first radio access technology and scheduled for resources associated with a second radio access technology on the sidelink band.

7. The apparatus of claim 1, wherein the uplink message is associated with a set of resources on the sidelink band that is excluded from sidelink communications.

8. The apparatus of claim 1, wherein the instructions executable by the processor to transmit the capability message comprise instructions executable by the processor to:
transmit, via the capability message, an indication that the UE is capable of performing uplink transmissions using one or more of: the uplink band, the sidelink band, or the uplink band and the sidelink band simultaneously.

9. The apparatus of claim 8, wherein the instructions executable by the processor to transmit the capability message comprise instructions executable by the processor to:
transmit, via the capability message, an indication of a quantity or set of timing advance groups supported by the UE for simultaneous transmissions over the uplink band and the sidelink band.

10. The apparatus of claim 1, further comprising:
up to two transmissions are scheduled for the uplink band and the sidelink band.

11. The apparatus of claim 1, wherein a switching gap between receiving the grant and transmitting the uplink message is based at least in part on a switching period between bands in a same timing advance group and a defined maximum transmitted timing difference.

12. An apparatus for wireless communication, comprising:
a processor:
memory in electronic communication with the processor; and
instructions stored in the memory, wherein the instructions are executable by the processor to:
receive a capability message indicating a capability of a user equipment (UE) to perform uplink switching between an uplink band and a sidelink band:
transmit a grant scheduling an uplink message for transmission over a set of one or more transmit ports: and
receive the uplink message using the sidelink band according to the grant and based at least in part on a transmitter of the UE switching from the uplink band to the sidelink band.

13. The apparatus of claim 12, wherein the instructions are further executable by the processor to:
receive a feedback report associated with the grant over the sidelink band based at least in part on the transmitter of the UE switching, wherein the feedback report indicates that the switching was successful.

14. The apparatus of claim 12, wherein the instructions are further executable by the processor to:
receive a feedback report associated with the grant over the sidelink band based at least in part on the transmitter of the UE switching, wherein the feedback report indicates a conflict associated with the uplink message on the sidelink band.

15. The apparatus of claim 12, wherein the instructions to receive the uplink message are executable by the processor to:
receive the uplink message via one or more future slots of the sidelink band based at least in part on the grant.

16. The apparatus of claim 12, wherein the uplink message is associated with a first radio access technology and scheduled for resources associated with a second radio access technology on the sidelink band.

17. The apparatus of claim 12, wherein the uplink message is associated with a set of resources on the sidelink band that is excluded from sidelink communications.

18. The apparatus of claim 12, wherein the instructions executable by the processor to receive the capability message comprise instructions executable by the processor to:
receive, via the capability message, an indication that the UE is capable of performing uplink transmissions using one or more of the uplink band, the sidelink band, or the uplink band and the sidelink band simultaneously.

19. The apparatus of claim 18, wherein the instructions executable by the processor to receive the capability message comprise instructions executable by the processor to:
receive, via the capability message, an indication of a quantity or set of timing advance groups supported by the UE for simultaneous transmissions over the uplink band and the sidelink band.

20. The apparatus of claim 12, further comprising:
up to two transmissions are scheduled for the uplink band and the sidelink band.

21. The apparatus of claim 12, wherein a switching gap between transmitting the grant and receiving the uplink message is based at least in part on a switching period between bands in a same timing advance group and a defined maximum transmitted timing difference.

22. A method for wireless communication, comprising:
transmitting a capability message indicating a capability of a UE to perform uplink switching between an uplink band and a sidelink band:
receiving a grant scheduling an uplink message for transmission over a set of one or more transmit ports:
switching a transmitter of the UE from the uplink band to the sidelink band based at least in part on the set of one or more transmit ports and the capability message; and
transmitting the uplink message using the sidelink band according to the grant and based at least in part on the switching.

23. The method of claim 22, further comprising:
transmitting a feedback report associated with the grant over the sidelink band based at least in part on switching the transmitter of the UE, wherein the feedback report indicates that the switching was successful.

24. The method of claim 22, further comprising:
transmitting a feedback report associated with the grant over the sidelink band based at least in part on switching the transmitter of the UE, wherein the feedback report indicates a conflict associated with the uplink message on the sidelink band.

25. The method of claim 22, further comprising:
withholding a feedback report associated with the grant over the sidelink band based at least in part on a conflict associated with the uplink message on the sidelink band.

26. The method of claim 22, further comprising:
reserving one or more future slots of the sidelink band for transmitting the uplink message based at least in part on the grant.

27. A method for wireless communication, comprising:
receiving a capability message indicating a capability of a user equipment (UE) to perform uplink switching between an uplink band and a sidelink band;
transmitting a grant scheduling an uplink message for transmission over a set of one or more transmit ports; and
receiving the uplink message using the sidelink band according to the grant and based at least in part on a transmitter of the UE switching from the uplink band to the sidelink band.

28. The method of claim 27, further comprising:
receiving a feedback report associated with the grant over the sidelink band based at least in part on the transmitter of the UE switching, wherein the feedback report indicates that the switching was successful.

29. The method of claim 27, further comprising:
receiving a feedback report associated with the grant over the sidelink band based at least in part on the transmitter of the UE switching, wherein the feedback report indicates a conflict associated with the uplink message on the sidelink band.

30. The method of claim 27, wherein receiving the uplink message comprises:
receiving the uplink message via one or more future slots of the sidelink band based at least in part on the grant.
